(19) United States
(12) Patent Application Publication
(10) Pub. No.: US 2024/0289994 A1
(43) Pub. Date: Aug. 29, 2024

(54) POINT CLOUD DECODING DEVICE, POINT CLOUD DECODING METHOD, AND PROGRAM

(71) Applicant: KDDI CORPORATION, Tokyo (JP)

(72) Inventors: Kyohei UNNO, Fujimino-shi (JP); Kei KAWAMURA, Fujimino-shi (JP)

(73) Assignee: KDDI CORPORATION, Tokyo (JP)

(21) Appl. No.: 18/595,157

(22) Filed: Mar. 4, 2024

Related U.S. Application Data
(63) Continuation of application No. PCT/JP2023/000013, filed on Jan. 4, 2023.

(30) Foreign Application Priority Data
Jan. 7, 2022 (JP) 2022-001468

(51) Int. Cl. G06T 9/00; G06T 7/62

(52) U.S. Cl. CPC G06T 9/001; G06T 7/62

(57) ABSTRACT

A point cloud decoding device (200) including a circuit that selects, as a projection plane, a projection plane having a largest area of a polygon defined by a plurality of vertices existing on sides of a node when the plurality of vertices are projected onto each of a plurality of projection plane candidates, from among the plurality of projection plane candidates.

### CROSS-REFERENCE TO RELATED APPLICATIONS

The present application is a continuation of PCT Application No. PCT/JP2023/000013, filed on Jan. 4, 2023, which claims the benefit of Japanese patent application No. 2022-001468 filed on Jan. 7, 2022, the entire contents of which are incorporated herein by reference in its entirety.

### TECHNICAL FIELD

The present invention relates to a point cloud decoding device, a point cloud decoding method, and a program.

### BACKGROUND ART

Non Patent Literature 1 discloses a technology of determining a projection plane by evaluating a one-dimensional spread of vertex coordinates belonging to a node in Trisoup.

### CITATION LIST

### Non Patent Literature

Non Patent Literature 1: G-PCC Future Enhancement, ISO/IEC JTC1/SC29/WG11 N19328

### SUMMARY OF THE INVENTION

However, in the method of Non Patent Literature 1, since a two-dimensional spread of coordinates when a vertex is projected onto a projection plane cannot be considered, there is a problem that an appropriate projection plane cannot be selected, and a subjective image quality of a decoded point cloud may be impaired.

Therefore, the present invention has been made in view of the above-described problems, and an object of the present invention is to provide a point cloud decoding device, a point cloud decoding method, and a program capable of improving a subjective image quality of a decoded point cloud.

A first aspect of the present invention is summarized as a point cloud decoding device including a circuit that selects, as a projection plane, a projection plane having a largest area of a polygon defined by a plurality of vertices existing on sides of a node when the plurality of vertices are projected onto each of a plurality of projection plane candidates, from among the plurality of projection plane candidates.

A second aspect of the present invention is summarized as a point cloud decoding device including a circuit that classifies each side of a node based on whether or not each side is parallel to any of coordinate axes of three-dimensional coordinates, and determine the projection plane from among a plurality of projection plane candidates by using the number of vertices on the side classified as each coordinate axis.

A third aspect of the present invention is summarized as a point cloud decoding method including: selecting, as a projection plane, a projection plane having a largest area of a polygon defined by a plurality of vertices existing on sides of a node when the plurality of vertices are projected onto each of a plurality of projection plane candidates, from among the plurality of projection plane candidates.

A fourth aspect of the present invention is summarized as a program stored on a non-transitory computer-readable medium for causing a computer to function as a point cloud decoding device including a circuit that selects, as a projection plane, a projection plane having a largest area of a polygon defined by a plurality of vertices existing on sides of a node when the plurality of vertices are projected onto each of a plurality of projection plane candidates, from among the plurality of projection plane candidates.

According to the present invention, it is possible to provide a point cloud decoding device, a point cloud decoding method, and a program capable of improving a subjective image quality of a decoded point cloud.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to an embodiment.

FIG. 3 is a diagram illustrating an example of a configuration of encoded data (bit stream) received by a geometric information decoding unit 2010 of the point cloud decoding device 200 according to an embodiment.

FIG. 4 is a diagram illustrating an example of a syntax configuration of a GPS 2011.

FIG. 5 is a diagram illustrating an example of a syntax configuration of a GSH 2012.

FIG. 6 is a flowchart illustrating an example of processing in a tree synthesizing unit 2020 of the point cloud decoding device 200 according to an embodiment.

FIG. 7 is a flowchart illustrating an example of decoding processing of an occupancy code for each node by the tree synthesizing unit 2020 of the point cloud decoding device 200 according to an embodiment.

FIG. 8 is a flowchart illustrating an example of processing of selecting any one of four types of contexts (no pred/pred0/pred1/predL) by using inter prediction by the tree synthesizing unit 2020 of the point cloud decoding device 200 according to an embodiment.

FIG. 9 is a flowchart illustrating an example of processing of an approximate-surface synthesizing unit 2030 of the point cloud decoding device 200 according to an embodiment.

FIG. 10 is a flowchart illustrating an example of decoding processing of a vertex position of Trisoup by the approximate-surface synthesizing unit 2030 of the point cloud decoding device 200 according to an embodiment.

FIG. 11 is a diagram for explaining an example of processing of step S1006 in FIG. 10.

FIGS. 12-1, 12-2 and 12-3 are diagrams for explaining examples of processing of step S1006 in FIG. 10.

FIG. 13 is a diagram for explaining another example of the processing of step S1006 in FIG. 10.

FIGS. 14-1 and 14-2 are diagrams for explaining other examples of the processing of step S1006 in FIG. 10.

FIG. 15 is a diagram for explaining an example of processing of step S902 in FIG. 9.

FIGS. 16-1, 16-2 and 16-3 are diagrams for explaining examples of processing of step S902 in FIG. 9.

FIG. 17 is a diagram for explaining another example of the processing of step S902 in FIG. 9.

FIG. 18 is a diagram for explaining another example of the processing of step S902 in FIG. 9.

FIGS. 19-1, 19-2 and 19-3 are diagrams for explaining other examples of the processing of step S902 in FIG. 9.

FIGS. 20-1, 20-2, 20-3 and 20-4 are diagrams for explaining other examples of the processing of step S902 in FIG. 9.

FIG. 21 is a diagram illustrating an example of functional blocks of a point cloud encoding device 100 according to an embodiment.

FIG. 22 is a diagram for explaining an example of processing of step S902 in FIG. 9.

### DESCRIPTION OF EMBODIMENTS

An embodiment of the present invention will be explained hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

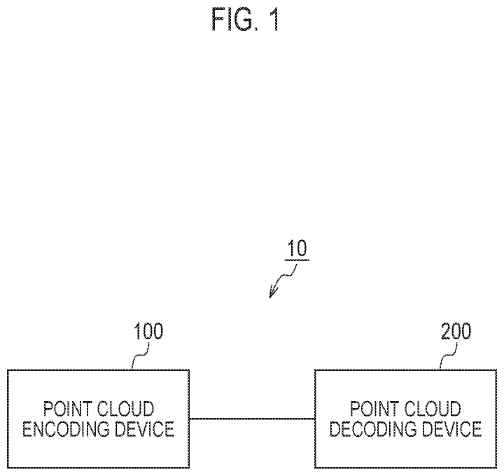

Hereinafter, with reference to FIG. 1 to FIG. 22, a point cloud processing system 10 according to a first embodiment of the present invention will be described. FIG. 1 is a diagram illustrating the point cloud processing system 10 according to an embodiment according to the present embodiment.

As illustrated in FIG. 1, the point cloud processing system 10 has a point cloud encoding device 100 and a point cloud decoding device 200.

The point cloud encoding device 100 is configured to generate encoded data (bit stream) by encoding input point cloud signals. The point cloud decoding device 200 is configured to generate output point cloud signals by decoding the bit stream.

Note that the input point cloud signals and the output point cloud signals include position information and attribute information of points in point clouds. The attribute information is, for example, color information or a reflection ratio of each point.

Herein, the bit stream may be transmitted from the point cloud encoding device 100 to the point cloud decoding device 200 via a transmission path. The bit stream may be stored in a storage medium and then provided from the point cloud encoding device 100 to the point cloud decoding device 200.

### (Point Cloud Decoding Device 200)

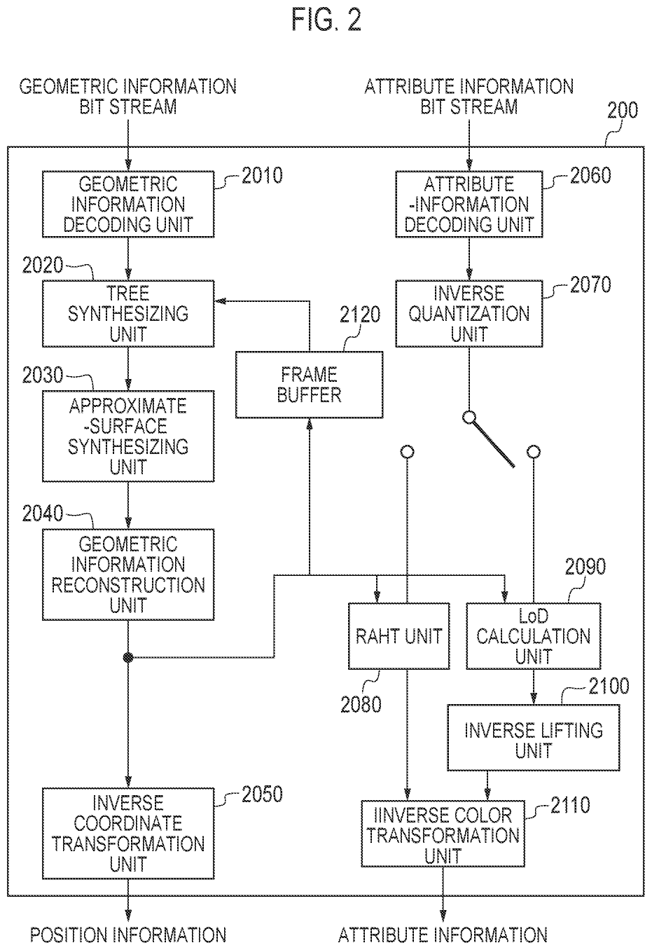

Hereinafter, with reference to FIG. 2, the point cloud decoding device 200 according to the present embodiment will be described. FIG. 2 is a diagram illustrating an example of functional blocks of the point cloud decoding device 200 according to the present embodiment.

As illustrated in FIG. 2, the point cloud decoding device 200 includes a geometric information decoding unit 2010, a tree synthesizing unit 2020, an approximate-surface synthesizing unit 2030, a geometric information reconstruction unit 2040, an inverse coordinate transformation unit 2050, an attribute-information decoding unit 2060, an inverse quantization unit 2070, a region adaptive hierarchical transform (RAHT) unit 2080, a level-of-detail (LoD) calculation unit 2090, an inverse lifting unit 2100, an inverse color transformation unit 2110, and a frame buffer 2120.

The geometry information decoding unit 2010 is configured to use, as input, a bit stream about geometry information (geometry information bit stream) among bit streams output from the point cloud encoding device 100 and to decode syntax.

A decoding process is, for example, a context-adaptive binary arithmetic decoding process. Herein, for example, the syntax includes control data (flags and parameters) for controlling the decoding process of the position information.

The tree synthesizing unit 2020 is configured to use, as input, control data, which has been decoded by the geometry information decoding unit 2010, and later-described occupancy code that shows on which nodes in a tree a point cloud is present and to generate tree information about in which regions in a decoding target space points are present.

Note that the tree synthesizing unit 2020 may be configured to perform decoding processing of an occupancy code.

The present process can generate the tree information by recursively repeating a process of sectioning the decoding target space by cuboids, determining whether the points are present in each cuboid by referencing the occupancy code, dividing the cuboid in which the points are present into plural cuboids, and referencing the occupancy code.

Here, inter prediction described later may be used in decoding the occupancy code.

In the present embodiment, there can be used a method called “Octree” in which octree division is recursively carried out with the above described cuboids always as cubes and a method called “QtBt” in which quadtree division and binary tree division are carried out in addition to octree division. Whether or not “QtBt” is to be used is transmitted as the control data from the point cloud encoding device 100 side.

Alternatively, in a case where the control data specifies that later-described Predicitive coding is to be used, the tree synthesizing unit 2020 is configured to decode the coordinates of each point, based on a tree configuration determined in the point cloud encoding device 100.

The approximate-surface synthesizing unit 2030 is configured to generate approximate-surface information by using the tree information generated by the tree-information synthesizing unit 2020.

In a case where point clouds are densely distributed on a surface of an object, for example, when three-dimensional point cloud data of the object is to be decoded, the approximate-surface information approximates and expresses the region in which the point clouds are present by a small flat surface instead of decoding the individual point clouds.

Specifically, the approximate-surface synthesizing unit 2030 can generate the approximate-surface information, for example, by a method called “Trisoup”. As specific processes of “Trisoup”, for example, the methods described in Non Patent Literatures 1 and 2 can be used. When sparse point cloud data acquired by Lidar or the like is to be decoded, the present process can be omitted.

The geometry information reconfiguration unit 2040 is configured to reconfigure the geometry information of each point of the decoding-target point cloud (position information in a coordinate system assumed by the decoding process) based on the tree information generated by the tree-information synthesizing unit 2020 and the approximate-surface information generated by the approximate-surface synthesizing unit 2030.

The inverse coordinate transformation unit 2050 is configured to use the geometry information, which has been reconfigured by the geometry information reconfiguration unit 2040, as input, to transform the coordinate system assumed by the decoding process to a coordinate system of the output point cloud signals, and to output the position information.

The frame buffer 2120 is configured to store geometry information reconfigured by the geometric information reconstruction unit 2040 as a reference frame as an input. The stored reference frame is read from the frame buffer 2120 and used as a reference frame in a case where the tree synthesizing unit 2020 performs inter prediction of temporally different frames.

Here, which time reference frame is used for each frame may be determined based on, for example, control data transmitted as a bit stream from the point cloud encoding device 100.

The attribute-information decoding unit 2060 is configured to use, as input, a bit stream about the attribute information (attribute-information bit stream) among bit streams output from the point cloud encoding device 100 and to decode syntax.

A decoding process is, for example, a context-adaptive binary arithmetic decoding process. Herein, for example, the syntax includes control data (flags and parameters) for controlling the decoding process of the attribute information.

The attribute-information decoding unit 2060 is configured to decode quantized residual information from the decoded syntax.

The inverse quantization unit 2070 is configured to carry out an inverse quantization process and generate inverse-quantized residual information based on quantized residual information decoded by the attribute-information decoding unit 2060 and a quantization parameter which is part of the control data decoded by the attribute-information decoding unit 2060.

The inverse-quantized residual information is output to either one of the RAHT unit 2080 and LOD calculation unit 2090 depending on characteristics of the point cloud serving as a decoding target. The control data decoded by the attribute-information decoding unit 2060 specifies to which one the information is to be output.

The RAHT unit 2080 is configured to use, as input, the inverse-quantized residual information generated by the inverse-quantized residual information and the geometry information generated by the geometry information reconfiguration unit 2040 and to decode the attribute information of each point by using one type of Haar transformation (in a decoding process, inverse Haar transformation) called Region Adaptive Hierarchical Transform (RAHT). As specific processes of RAHT, for example, the methods described in Non Patent Literatures 1 and 2 can be used. As specific processing of RAHT, for example, a method described in Literature 1 ([PCC] An exploratory model for inter geometry-based PCC, ISO/IEC JTC1/SC29/WG11 m44754) can be used.

The LOD calculation unit 2090 is configured to use the geometry information, which has been generated by the geometry information reconfiguration unit 2040, as input and to generate Level of Detail (LOD).

LOD is the information for defining a reference relation (referencing point and point to be referenced) for realizing prediction encoding which predicts, from the attribute information of a certain point, the attribute information of another point and encodes or decodes prediction residual.

In other words, LOD is the information defining a hierarchical structure which categorizes the points included in the geometry information into plural levels and encodes or decodes the attributes of the point belonging to a lower level by using the attribute information of the point which belongs to a higher level.

As specific methods of determining LOD, for example, the methods described in Non Patent Literature 1 may be used. Other examples will be described later.

The inverse lifting unit 2100 is configured to decode the attribute information of each point based on the hierarchical structure defined by LoD by using the LOD generated by the LOD calculation unit 2090 and the inverse-quantized residual information generated by the inverse-quantized residual information. As specific processes of the inverse lifting, for example, the methods described in Non Patent Literature 1 can be used.

The inverse color transformation unit 2110 is configured to subject the attribute information, which is output from the RAHT unit 2080 or the inverse lifting unit 2100, to an inverse color transformation process when the attribute information of the decoding target is color information and when color transformation has been carried out on the point cloud encoding device 100 side. Whether to execute the inverse color transformation process or not is determined by the control data decoded by the attribute-information decoding unit 2060.

The point cloud decoding device 200 is configured to decode and output the attribute information of each point in the point cloud by the above described processes.

### (Geometric Information Decoding Unit 2010)

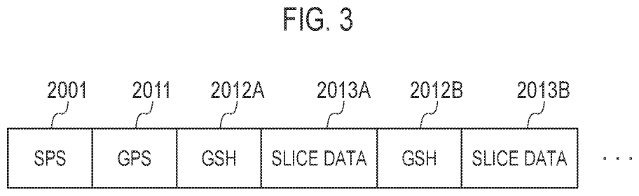

The control data decoded by the geometric information decoding unit 2010 will be described below with reference to FIGS. 3 to 5.

FIG. 3 is an example of a configuration of encoded data (bit stream) received by the geometric information decoding unit 2010.

First, the bit stream may include a GPS 2011. The GPS 2011 is also called a geometry parameter set, and is a set of control data related to decoding of the geometry information. A specific example thereof will be described later. Each GPS 2011 includes at least GPS id information for individually identifying a plurality of GPSs 2011.

Second, the bit stream may include a GSH 2012A/2012B. The GSH 2012A/2012B is also called a geometry slice header or a geometry data unit header, and is a set of control data corresponding to a slice to be described later. Hereinafter, a description will be given using the term “slice”, but the slice may be read as a data unit. A specific example thereof will be described later. The GSH 2012A/2012B includes at least GPS id information for designating the GPS 2011 corresponding to each of the GSH 2012A/2012B.

Third, the bit stream may include slice data 2013A/2013B next to the GSH 2012A/2012B. The slice data 2013A/2013B includes data obtained by encoding the geometry information. An example of the slice data 2013A/2013B includes the occupancy code to be described later.

As described above, in the bit stream, the GSH 2012A/2012B and the GPS 2011 correspond to each piece of slice data 2013A/2013B one by one.

As described above, since which GPS 2011 is referred to in the GSH 2012A/2012B is designated by the GPS id information, the GPS 2011 common to the pieces of slice data 2013A/2013B can be used.

In other words, the GPS 2011 does not necessarily need to be transmitted for each slice. For example, the bit stream may have a configuration in which the GPS 2011 is not encoded immediately before the GSH 2012B and the slice data 2013B as illustrated in FIG. 3.

Note that the configuration in FIG. 3 is merely an example. As long as the GSH 2012A/2012B and the GPS 2011 are configured to correspond to each piece of slice data 2013A/2013B, an element other than those described above may be added as a constituent element of the bit stream.

For example, as illustrated in FIG. 3, the bit stream may include a sequence parameter set (SPS) 2001. Similarly, the bit stream may have a configuration different from that in FIG. 3 at the time of transmission. Further, the bit stream may be synthesized with a bit stream decoded by the attribute-information decoding unit 2060 described later and transmitted as a single bit stream.

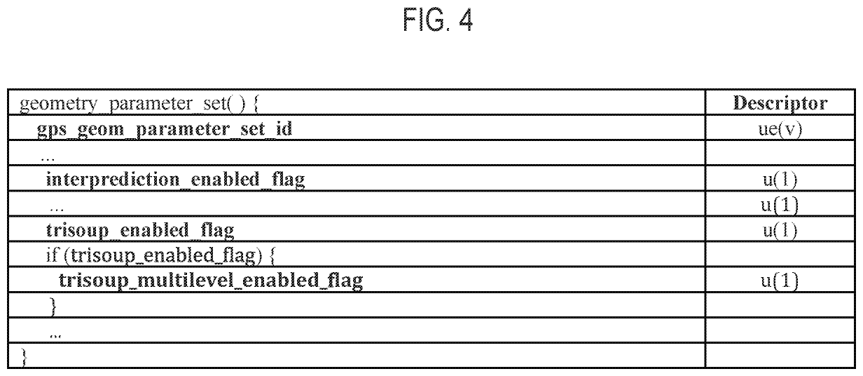

FIG. 4 is an example of a syntax configuration of the GPS 2011.

Note that syntax names described below are merely examples. The syntax names may vary as long as the functions of the syntaxes described below are similar.

The GPS 2011 may include the GPS id information (gps_geom_parameter_set_id) for identifying each GPS 2011.

Note that a Descriptor column in FIG. 4 indicates how each syntax is encoded. ue(v) means an unsigned 0-order exponential-Golomb code, and u(1) means a 1-bit flag.

The GPS 2011 may include a flag (interprediction_enabled_flag) that controls whether or not to perform inter prediction in the tree synthesizing unit 2020.

For example, when a value of interprediction_enabled_flag is “0”, it may be defined that inter prediction is not performed, and when a value of interprediction_enabled_flag is “1”, it may be defined that inter prediction is performed.

Note that interprediction_enabled_flag may be included in the SPS 2001 instead of the GPS 2011.

The GPS 2011 may include a flag (trisoup_enabled_flag) that controls whether or not to use Trisoup in the approximate-surface synthesizing unit 2030.

For example, when a value of trisoup_enabled_flag is “0”, it may be defined that Trisoup is not used, and when a value of trisoup_enabled_flag is “1”, it may be defined that Trisoup is used.

The geometric information decoding unit 2010 may be configured to additionally decode the following syntax when Trisoup is used, that is, when the value of trisoup_enabled_flag is “1”.

Note that trisoup_enabled_flag may be included in the SPS 2001 instead of the GPS 2011.

The GPS 2011 may include a flag (trisoup_multilevel_enabled_flag) (first flag) that controls whether or not to enable Trisoup at a plurality of levels.

For example, when a value of trisoup_multilevel_enabled_flag is “0”, it may be defined that Trisoup at a plurality of levels is not enabled, that is, Trisoup at a single level is performed, and when a value of trisoup_multilevel_enabled_flag is “1”, it may be defined that Trisoup at a plurality of levels is enabled.

When the syntax is not included in the GPS 2011, the value of the syntax may be regarded as a value in a case where Trisoup at a single level is performed, that is, “0”.

Note that trisoup_multilevel_enabled_flag may be defined to be included in the SPS 2001 instead of the GPS 2011. In this case, when trisoup_multilevel_enabled_flag is not included in the SPS 2001, the value of the syntax may be regarded as a value in a case where Trisoup at a single level is performed, that is, “0”.

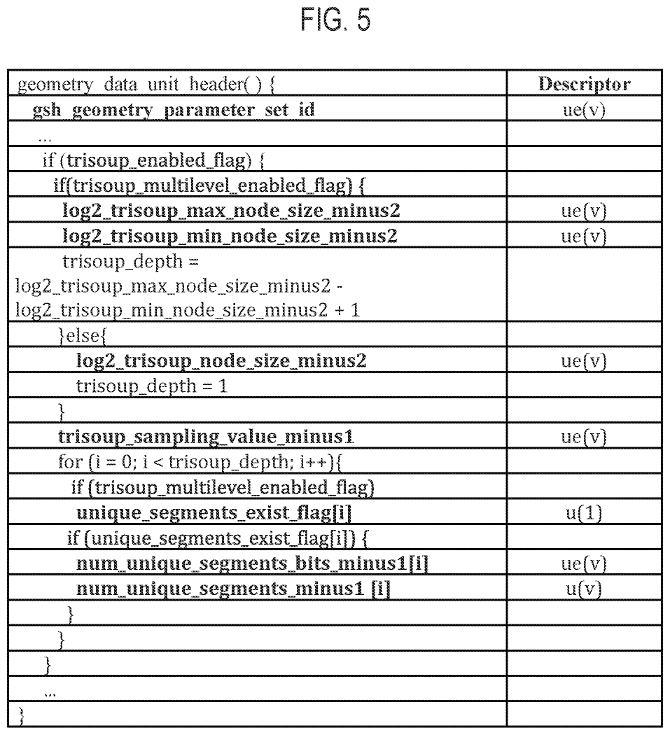

FIG. 5 illustrates an example of a syntax configuration of the GSH 2012. As described above, the GSH is also referred to as a geometry data unit header (GDUH).

The geometric information decoding unit 2010 may be configured to additionally decode the following syntax when Trisoup at a plurality of levels is enabled, that is, when the value of trisoup_multilevel_enabled_flag is “1”.

The GSH 2012 may include a syntax (log 2_trisoup_max_node_size_minus2) that defines the maximum value of a Trisoup node size when Trisoup at a plurality of levels is enabled.

The syntax may be expressed as a value obtained by converting the maximum value of the actual Trisoup node size into a logarithm having a base of 2. Furthermore, the syntax may be expressed as a value obtained by converting the maximum value of the actual Trisoup node size into a logarithm with a base of 2 and then subtracting 2.

The GSH 2012 may include a syntax (log 2_trisoup_min_node_size_minus2) that defines the minimum value of the Trisoup node size when Trisoup at a plurality of levels is enabled.

The syntax may be expressed as a value obtained by converting the minimum value of the actual Trisoup node size into a logarithm having a base of 2. Furthermore, the syntax may be expressed as a value obtained by converting the minimum value of the actual Trisoup node size into a logarithm with a base of 2 and then subtracting 2.

In addition, the value of the syntax may be restricted to be necessarily 0 or more and log 2_trisoup_max_node_size_minus2 or less.

Furthermore, at this time, as illustrated in FIG. 5, trisoup_depth may be defined as trisoup_depth=log 2_trisoup_max_node_size_minus2−log 2_trisoup_min_node_size_minus2+1.

The geometric information decoding unit 2010 may be configured to additionally decode the following syntax when Trisoup at a plurality of levels is not enabled, that is, when the value of trisoup_multilevel_enabled_flag is “0”.

The GSH 2012 may include a syntax (log 2_trisoup_node_size_minus2) that defines the Trisoup node size when Trisoup at a plurality of levels is not enabled and when Trisoup is used.

The syntax may be expressed as a value obtained by converting the actual Trisoup node size into a logarithm having a base of 2. Furthermore, the syntax may be expressed as a value obtained by converting the actual Trisoup node size into a logarithm having a base of 2 and then subtracting 2.

Furthermore, at this time, trisoup_depth may be defined as trisoup_depth=1 as illustrated in FIG. 5.

The GSH 2012 may include a syntax (trisoup_sampling_value_minus1) that controls a sampling interval of decoding points when Trisoup is used. A specific definition of the syntax can be, for example, similar to the definition described in Literature 1 described above.

The GSH 2012 may include a flag (unique_segments_exist_flag[i]) indicating whether or not an unique segment exists in a target hierarchy for each hierarchy i (i=0, . . . , trisoup_depth-1) when Trisoup is used and when Trisoup at a plurality of levels is enabled. For example, a value of unique_segments_exist_flag[i] of “1” means that at least one or more unique segments exist in the hierarchy i. A value of unique_segments_exist_flag[i] of “0” means that there is no unique segment in the hierarchy i.

The GSH 2012 may additionally include a syntax (num_unique_segments_bits_minus1 [i]) indicating the number of bits of a syntax indicating the number of unique segments of the target hierarchy and a syntax (num_unique_segments_minus1 [i]) indicating the number of unique segments of the target hierarchy when a unique segment exists in the target hierarchy for each hierarchy i (i=0, . . . , trisoup_depth-1), that is, when a value of unique_segments_exist_flag[i] is “1”.

Here, for both num_unique_segments_bits_minus1 [i] and num_unique_segments_minus1 [i], a value obtained by subtracting “1” from the original value may be encoded as a value of the syntax.

### (Tree Synthesizing Unit 2020)

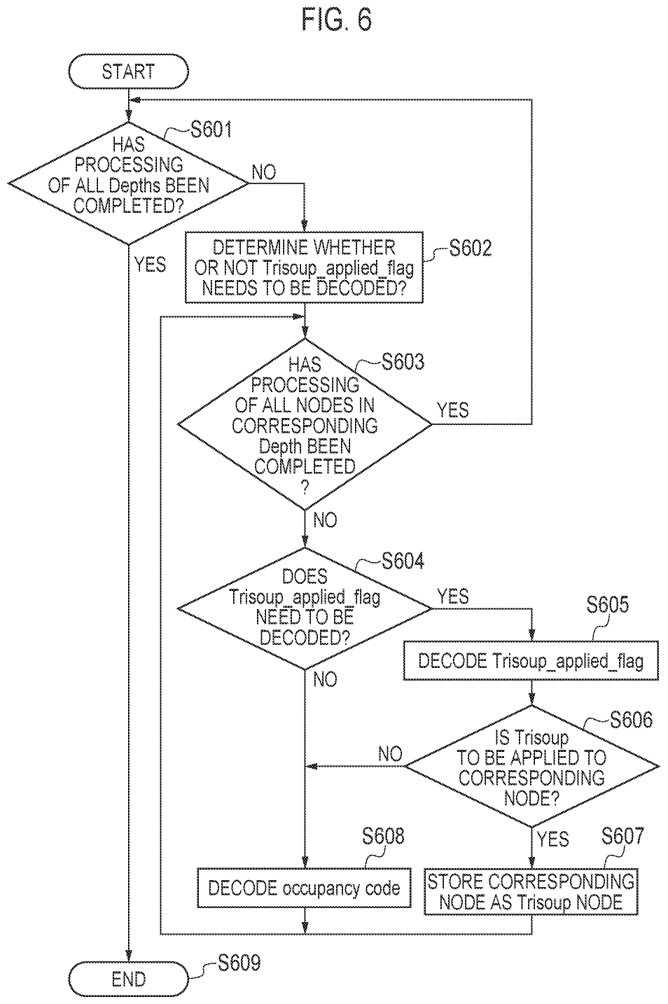

Hereinafter, processing in the tree synthesizing unit 2020 will be described with reference to FIGS. 6 to 8. FIG. 6 is a flowchart illustrating an example of processing in the tree synthesizing unit 2020. Note that an example of synthesizing a tree using “Octree” will be described below.

In step S601, the tree synthesizing unit 2020 checks whether or not processing of all the depths has been completed. Note that the number of depths may be included as control data in the bit stream transmitted from the point cloud encoding device 100 to the point cloud decoding device 200.

The tree synthesizing unit 2020 calculates a node size of a target depth. In the case of “Octree”, the node size of the first depth may be defined as “2 to the power of the number of depths”. That is, when the number of depths is N, the node size of the first depth may be defined as 2 to the power of N.

Furthermore, the node size of the second and subsequent depths may be defined by decreasing N one by one. That is, the node size of the second depth may be defined as “2 to the power of (N−1)”, the node size of the third depth may be defined as “2 to the power of (N−2)”, and the like.

Alternatively, since the node size is always defined by a power of 2, a value of the exponential part (N, N−1, N−2, or the like) may be simply considered as the node size. In the following description, the node size refers to the value of the exponential part.

In a case where the processing of all the depths has been completed, the tree synthesizing unit 2020 proceeds to step S609, and in a case where the processing of all the depths has not been completed, the tree synthesizing unit 2020 proceeds to step S602.

In other words, in a case where (N−n)=0 when the target depth is the n-th depth, the tree synthesizing unit 2020 proceeds to step S609, and in a case where (N−n)>0, the tree synthesizing unit 2020 proceeds to step S602.

Here, when the flag (trisoup_enabled_flag) for controlling whether or not to use Trisoup indicates that Trisoup is used, that is, when the value of trisoup_enabled_flag is “1”, the tree synthesizing unit 2020 may change the number of depths to be processed based on the value of the syntax (log 2_trisoup_min_node_size_minus2) that defines the minimum value of the Trisoup node size or the syntax (log 2_trisoup_node_size_minus2) that defines the Trisoup node size. In such a case, for example, it may be defined as follows.

Number of depths to be processed=Total number of depths−(Minimum)Trisoup node size

Here, the minimum Trisoup node size can be defined by, for example, (log 2_trisoup_min_node_size_minus2+2). Similarly, the Trisoup node size can be defined by (log 2_trisoup_node_size_minus2+2).

In this case, in a case where the processing of all the depths to be processed is completed, the tree synthesizing unit 2020 proceeds to step S609, and otherwise, the tree synthesizing unit 2020 proceeds to step S602.

In other words, in a case where (the number of depths to be processed−n)=0, the tree synthesizing unit 2020 proceeds to step S609, and in a case where (the number of depths to be processed−n)>0, the tree synthesizing unit 2020 proceeds to step S602.

Furthermore, the tree synthesizing unit 2020 may determine that Trisoup is applied to all the nodes having the node size (N−the number of depths to be processed) when proceeding to step S609.

In step S602, the tree synthesizing unit 2020 determines whether or not Trisoup_applied_flag described later needs to be decoded at the target depth.

For example, when “Trisoup at a plurality of levels is enabled (the value of trisoup_multilevel_enabled_flag is “1”)” and “the node size (N−n) of the target depth is equal to or smaller than the maximum Trisoup node size”, the tree synthesizing unit 2020 may determine that “Trisoup_applied_flag needs to be decoded”.

Furthermore, in a case where the above-described condition is not satisfied, the tree synthesizing unit 2020 may determine that “Trisoup_applied_flag does not need to be decoded”.

Here, the maximum Trisoup node size can be defined by, for example, (log 2_trisoup_max_node_size_minus3+2).

When the above-described determination is completed, the tree synthesizing unit 2020 proceeds to step S603.

In step S603, the tree synthesizing unit 2020 determines whether or not the processing of all the nodes included in the target depth has been completed.

When the tree synthesizing unit 2020 determines that the processing of all the nodes of the target depth has been completed, the tree synthesizing unit 2020 proceeds to step S601 and performs processing of the next depth.

On the other hand, when the processing of all the nodes of the target depth has not been completed, the tree synthesizing unit 2020 proceeds to step S604.

In step S604, the tree synthesizing unit 2020 checks the necessity of decoding of Trisoup_applied_flag determined in step S602.

When the tree synthesizing unit 2020 determines that Trisoup_applied_flag needs to be decoded, the tree synthesizing unit 2020 proceeds to step S605, and when the tree synthesizing unit 2020 determines that Trisoup_applied_flag does not need to be decoded, the tree synthesizing unit 2020 proceeds to step S608.

In step S605, the tree synthesizing unit 2020 decodes Trisoup_applied_flag.

Trisoup_applied_flag is a 1-bit flag (second flag) indicating whether or not to apply Trisoup to the target node. For example, Trisoup may be defined to be applied to the target node when a value of the flag is “1”, and Trisoup may be defined not to be applied to the target node when the value of the flag is “0”.

The tree synthesizing unit 2020 decodes Trisoup_applied_flag, and then proceeds to step S606.

In step S606, the tree synthesizing unit 2020 checks the value of Trisoup_applied_flag decoded in step S605.

In a case where Trisoup is applied to the target node, that is, in a case where the value of Trisoup_applied_flag is “1”, the tree synthesizing unit 2020 proceeds to step S607.

In a case where Trisoup is not applied to the target node, that is, in a case where the value of Trisoup_applied_flag is “0”, the tree synthesizing unit 2020 proceeds to step S608.

In step S607, the tree synthesizing unit 2020 stores the target node as a node to which Trisoup is applied, that is, a Trisoup node. No further node division by “Octree” is to be applied to the target node. Thereafter, the tree synthesizing unit 2020 proceeds to step S603 and proceeds to processing of the next node.

In step S608, the tree synthesizing unit 2020 decodes information called the occupancy code.

In the case of “Octree”, the occupancy code is information indicating whether or not a point to be decoded is included in each child node when the target node is divided into eight nodes (referred to as child nodes) by dividing the target node in half in each of x, y, and z axis directions.

For example, the occupancy code may be defined in such a way that information of one bit is allocated to each child node, and when the information of one bit is “1”, the point to be decoded is included in the child node, and when the information of one bit is “0”, the point to be decoded is not included in the child node.

When decoding such an occupancy code, the tree synthesizing unit 2020 may estimate in advance a probability that the point to be decoded exists in each child node, and perform entropy decoding on a bit corresponding to each child node based on the probability.

Similarly, the point cloud encoding device 100 may perform entropy coding. Further, inter prediction may be used to estimate the probability. As a specific method of inter prediction, for example, the method described in Literature 1 described above can be applied. Furthermore, an upsampled point cloud may be used as a reference point cloud when performing inter prediction.

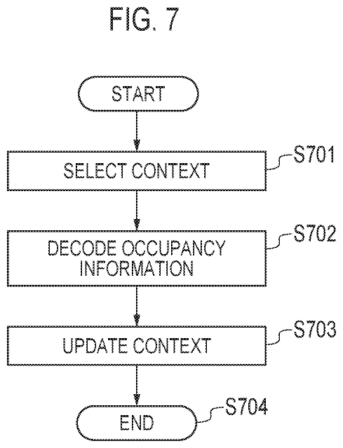

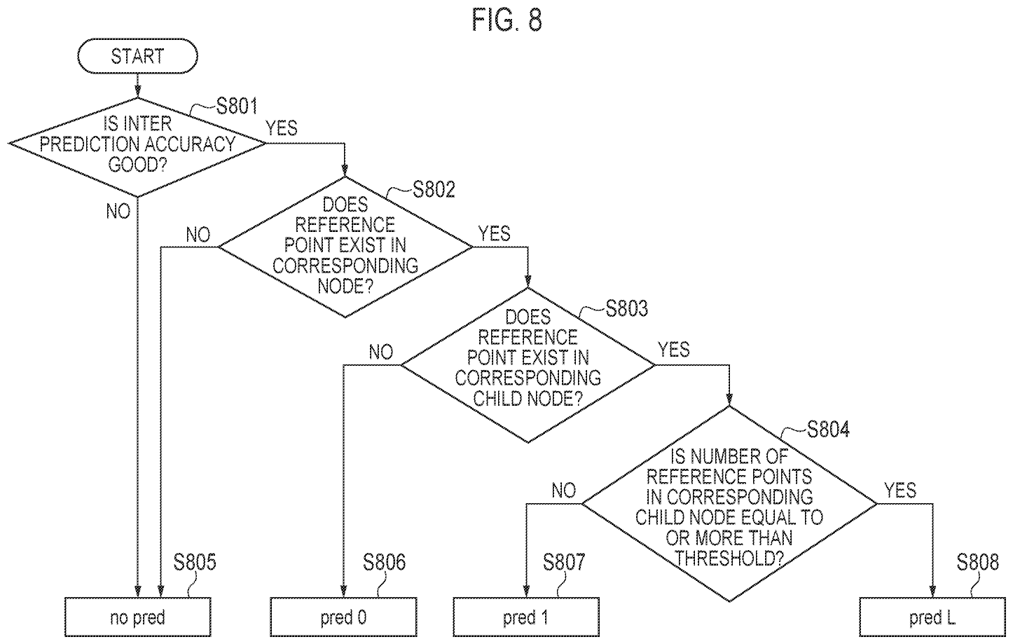

A specific example of the decoding processing of the occupancy code in a case of using inter prediction will be described with reference to FIGS. 7 to 8.

FIG. 7 is a flowchart illustrating a specific example of the decoding processing of the occupancy code for each node. In other words, FIG. 7 is a flowchart illustrating a specific example of the processing of step S608 in FIG. 6.

As illustrated in FIG. 7, in step S701, the tree synthesizing unit 2020 selects a context. The context corresponds to a probability distribution used in entropy decoding at the time of subsequent occupancy information decoding.

FIG. 8 is an example of a flowchart in a case where any one of four types of contexts (no pred/pred0/pred1/predL) is selected using inter prediction.

An example of context selection will be described below with reference to FIG. 8. Although FIG. 8 illustrates an example in which there are four types of contexts, the number of contexts does not have to be four.

As illustrated in FIG. 8, in step S801, the tree synthesizing unit 2020 determines inter prediction accuracy.

The inter prediction accuracy can be determined based on, for example, the selected context and the presence or absence of an actual point for a child node (eight child nodes for octree) in a parent node of the target node.

For example, regarding the child node for which the context of pred0 is selected, a case where no point actually exists is regarded as a correct answer, and a case where a point actually exists is regarded as an incorrect answer. On the other hand, for the child node for which pred1 or predL is selected, a case where a point actually exists is regarded as a correct answer, and a case where no point actually exists is regarded as an incorrect answer.

Here, in a case where the number of child nodes determined to be correct among the child nodes belonging to the parent node is larger than a predetermined threshold, it can be determined that the inter prediction accuracy is “good”. On the other hand, in a case where the number of child nodes determined to be correct among the child nodes belonging to the parent node is equal to or less than the predetermined threshold, it can be determined that the inter prediction accuracy is “poor”.

When the tree synthesizing unit 2020 determines that the inter prediction accuracy is “good”, the tree synthesizing unit 2020 proceeds to step S802. When the tree synthesizing unit 2020 determines that the inter prediction accuracy is “poor”, the tree synthesizing unit 2020 proceeds to step S805, sets the context to “no pred” for all the child nodes belonging to the target node, and ends the processing.

In step S802, the tree synthesizing unit 2020 checks whether or not at least one reference point exists in a region at the same position as the target node in a motion-compensated reference frame.

In a case where at least one reference point exists in the region at the same position as the target node, the tree synthesizing unit 2020 proceeds to step S803. On the other hand, in a case where there is no reference point in the region at the same position as the target node, the tree synthesizing unit 2020 proceeds to step S805, sets the context to “no pred” for all the child nodes belonging to the target node, and ends the processing.

In step S803 and subsequent steps, the tree synthesizing unit 2020 makes a determination for each child node belonging to the target node.

In step S803, the tree synthesizing unit 2020 checks whether or not at least one reference point exists in the region at the same position as a target child node in the motion-compensated reference frame.

In a case where at least one reference point exists in the region at the same position as the target child node, the tree synthesizing unit 2020 proceeds to step S804. On the other hand, when there is no reference point in the region at the same position as the target child node, the tree synthesizing unit 2020 proceeds to step S806 and sets the context of the target child node to “pred0”.

When context selection has not been completed for all the child nodes of the target node, the tree synthesizing unit 2020 returns to step S803 and performs similar processing for the next child node.

When the context selection has been completed for all the child nodes of the target node, the tree synthesizing unit 2020 ends the processing.

In step S804, the tree synthesizing unit 2020 checks whether or not reference points of which the number is equal to or larger than a predetermined threshold exist in the region at the same position as the target child node in the motion-compensated reference frame.

When the reference points whose number is equal to or larger than the predetermined threshold exist in the region at the same position as the target child node, the tree synthesizing unit 2020 proceeds to step S808 and sets the context of the target child node to “predL”.

On the other hand, in a case where only reference points whose number is less than the predetermined threshold exist in the region at the same position as the target child node, the tree synthesizing unit 2020 proceeds to step S807 and sets the context of the target child node to “pred1”.

After the processing of step S807 or S808, in a case where context selection has not been completed for all the child nodes of the target node, the tree synthesizing unit 2020 returns to step S804 and performs similar processing for the next child node.

When the context selection has been completed for all the child nodes of the target node, the tree synthesizing unit 2020 ends the processing.

After selecting the context as described above, the tree synthesizing unit 2020 proceeds to step S702.

In step S702, the tree synthesizing unit 2020 decodes occupancy information of each child node of the target node, that is, the occupancy code, based on the context selected in step S701.

Here, the contexts correspond to independent probability distributions. The probability that the point to be decoded exists is learned for each context by context update in step S703 described later.

Note that an initial value of the probability distribution in each context can be defined as, for example, a probability of 50% that the point exists (=a probability that the point does not exist is also 50%).

In step S702, the tree synthesizing unit 2020 performs entropy decoding based on the probability distribution corresponding to the context, and decodes whether or not the point exists in each child node (whether or not the value is “1”) (whether or not the value is “0”). After decoding of the occupancy code is completed, the tree synthesizing unit 2020 proceeds to step S703.

In step S703, the tree synthesizing unit 2020 updates the context.

For example, in step S703, in a case where a result point obtained by decoding the occupancy information exists in each context, the tree synthesizing unit 2020 updates the probability distribution associated with each context in such a way that the probability that the point exists increases.

On the other hand, in step S703, in a case where the result point obtained by decoding the occupancy information does not exist in each context, the tree synthesizing unit 2020 updates the probability distribution associated with each context in such a way that the probability that the point exists decreases.

When the context update is completed, the tree synthesizing unit 2020 proceeds to step S704 and ends the processing.

After decoding the occupancy code, the tree synthesizing unit 2020 proceeds to step S603 and proceeds to processing of the next node.

### (Approximate-Surface Synthesizing Unit 2030)

As described with reference to FIG. 6, the approximate-surface synthesizing unit 2030 is configured to perform decoding processing on each node determined to be the Trisoup node by the tree synthesizing unit 2020.

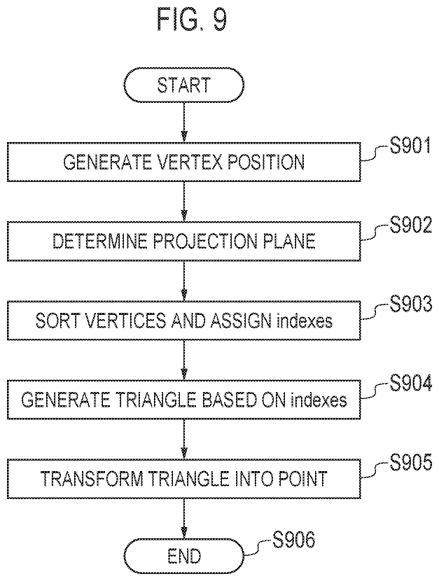

Hereinafter, an example of processing in the approximate-surface synthesizing unit 2030 will be described with reference to FIGS. 9 to 20.

FIG. 9 is a flowchart illustrating an example of the processing in the approximate-surface synthesizing unit 2030.

As illustrated in FIG. 9, in step S901, the approximate-surface synthesizing unit 2030 decodes a vertex position for each node.

Here, when Trisoup at a plurality of levels is enabled, that is, when the value of trisoup_multilevel_enabled_flag is “1”, the approximate-surface synthesizing unit 2030 decodes the vertex position for each node in the minimum Trisoup node size.

On the other hand, when Trisoup at a plurality of levels is not enabled, that is, when the value of trisoup_multilevel_enabled_flag is “0”, the approximate-surface synthesizing unit 2030 decodes the vertex position for each node in the Trisoup node size. Specific processing will be described later.

After the decoding of the vertex position is completed, the approximate-surface synthesizing unit 2030 proceeds to step S902.

In step S902, the approximate-surface synthesizing unit 2030 determines a projection plane for each node (the minimum Trisoup node size or for each node in the Trisoup node size) for which the vertex position has been decoded.

For example, when there are three axes of an x axis, a y axis, and a z axis, a plane obtained by degenerating any one axis is referred to as the projection plane.

In step S902, the approximate-surface synthesizing unit 2030 determines which one of the above-described axes is to be degenerated, that is, which one of an x-y plane, an x-z plane, and a y-z plane is to be the projection plane. Specific processing will be described later.

After determining the projection plane, the approximate-surface synthesizing unit 2030 proceeds to step S903.

In step S903, the approximate-surface synthesizing unit 2030 sorts vertices projected onto the projection plane in, for example, a counterclockwise order, and assigns indexes according to the above order.

After assigning the indexes, the approximate-surface synthesizing unit 2030 proceeds to step S904.

In step S904, the approximate-surface synthesizing unit 2030 generates a triangle based on the above-described indexes and the number of vertices existing in the target node.

For example, the approximate-surface synthesizing unit 2030 creates a table defining from which indexes the triangle is generated for each number of vertices in advance, and can generate the triangle by referring to the table. As a specific example of the table, for example, the table described in Literature 1 described above can be used.

After generating the triangle, the approximate-surface synthesizing unit 2030 proceeds to step S905.

In step S905, the approximate-surface synthesizing unit 2030 generates a point based on the triangle generated in step S904. As a specific method, for example, the method described in Literature 1 described above can be used.

After the point generation is completed for all the nodes, the approximate-surface synthesizing unit 2030 proceeds to step S906 and ends the processing.

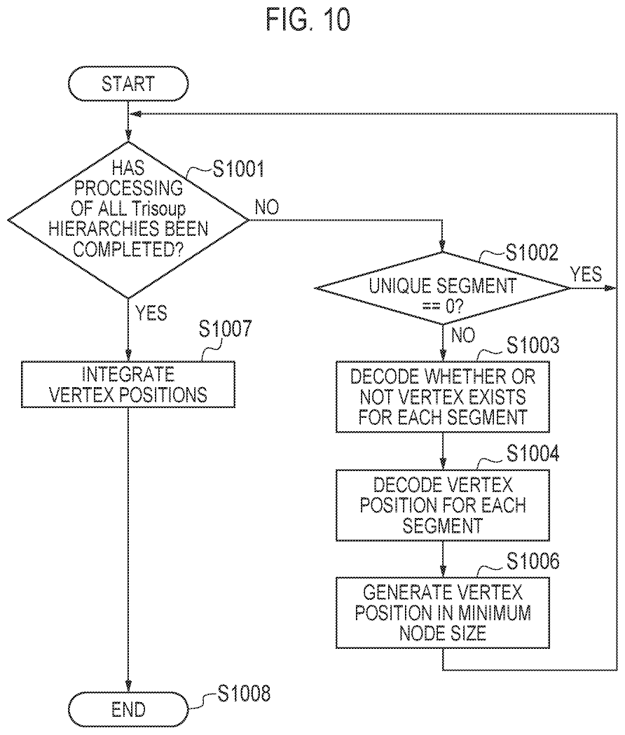

Next, a specific example of processing for the decoding of the vertex position in step S901 will be described. FIG. 10 is a flowchart illustrating an example of the decoding processing of the vertex position of Trisoup.

As illustrated in FIG. 10, in step S1001, the approximate-surface synthesizing unit 2030 determines whether or not processing of all Trisoup hierarchies has been completed. Here, the number of all Trisoup hierarchies can be defined as follows.

When Trisoup at a plurality of levels is enabled, that is, when the value of trisoup_multilevel_enabled_flag is “1”, the total number of Trisoup hierarchies can be defined by (maximum Trisoup node size-minimum Trisoup node size+1).

That is, in such a case, the total number of Trisoup hierarchies can be defined by (log 2_trisoup_max_node_size_minus2−log 2_trisoup_min_node_size_minus2+1).

When Trisoup at a plurality of levels is not enabled, that is, when the value of trisoup_multilevel_enabled_flag is “0”, the total number of Trisoup hierarchies is one.

When the processing of all the Trisoup hierarchies has been completed, the approximate-surface synthesizing unit 2030 proceeds to step S1007. When the processing of all the Trisoup hierarchies has not been completed, the approximate-surface synthesizing unit 2030 proceeds to step S1002.

In step S1002, the approximate-surface synthesizing unit 2030 checks the number of unique segments belonging to a target Trisoup hierarchy.

When the number of unique segments is “0”, that is, when no Trisoup node is included in the target Trisoup hierarchy, the approximate-surface synthesizing unit 2030 proceeds to step S1001 and proceeds to processing of the next Trisoup hierarchy.

When the number of unique segments is larger than “0”, the approximate-surface synthesizing unit 2030 proceeds to step S1003.

In step S1003, the approximate-surface synthesizing unit 2030 decodes whether or not a vertex used for Trisoup processing is included for each unique segment.

Note that the number of vertices that can exist for each unique segment may be limited to one. In this case, it can be interpreted that the number of unique segments in which the vertex exists is equal to the number of vertices.

The approximate-surface synthesizing unit 2030 decodes the presence or absence of the vertex for all the unique segments of the target Trisoup hierarchy, and then proceeds to step S1004.

In step S1004, the approximate-surface synthesizing unit 2030 decodes position information indicating where the vertex exists in each unique segment for each unique segment for which it is determined that the vertex exists in step S1003.

For example, in a case where the Trisoup node size in the target Trisoup hierarchy is L (2 to the power of L), the position information may be encoded with an equal length code of L bits.

The approximate-surface synthesizing unit 2030 decodes the vertex position for all the unique segments in which the vertex exists in the target Trisoup hierarchy, and then proceeds to step S1006.

In step S1006, when the node size in the target Trisoup hierarchy is the minimum Trisoup node size, the approximate-surface synthesizing unit 2030 proceeds to S1001 without performing any processing.

Similarly, when Trisoup at a plurality of levels is not enabled, the approximate-surface synthesizing unit 2030 does not perform any processing and proceeds to step S1001.

Otherwise, that is, when Trisoup at a plurality of levels is enabled and the node size in the target Trisoup hierarchy is larger than the minimum Trisoup node size, the approximate-surface synthesizing unit 2030 generates the vertex position in the minimum Trisoup node size based on the vertex position in the node size corresponding to the target Trisoup hierarchy decoded in step S1004. A specific processing example will be described later.

After the generation of the vertex position in the minimum node size is completed, the approximate-surface synthesizing unit 2030 proceeds to step S1001.

In step S1007, the approximate-surface synthesizing unit 2030 integrates the vertex positions.

For example, in a case where the approximate-surface synthesizing unit 2030 generates the vertex position in the minimum Trisoup node size from the vertex position in the larger node size in step S1006, there is a possibility that two or more vertices are generated on each side of the node.

In a case where there is a side on which two or more vertices are generated, the approximate-surface synthesizing unit 2030 integrates the sides into one point so that the number of vertices become one for each side.

For example, the approximate-surface synthesizing unit 2030 can integrate a plurality of points into one point by taking an average value of coordinates of the vertices existing on the side.

As another example, in a case where the number of vertices is an odd number, the approximate-surface synthesizing unit 2030 can narrow down the vertices to one by selecting a point having a median value of the coordinates.

Furthermore, in a case where the number of vertices is an even number, the approximate-surface synthesizing unit 2030 extracts two points having the median value of the coordinates, and then averages the coordinate values of the two points, so that the vertices can be narrowed down to one.

After integrating the vertices one by one for all the sides, the approximate-surface synthesizing unit 2030 proceeds to step S1008 and ends the processing.

Next, a specific example of the processing of step S1006 will be described.

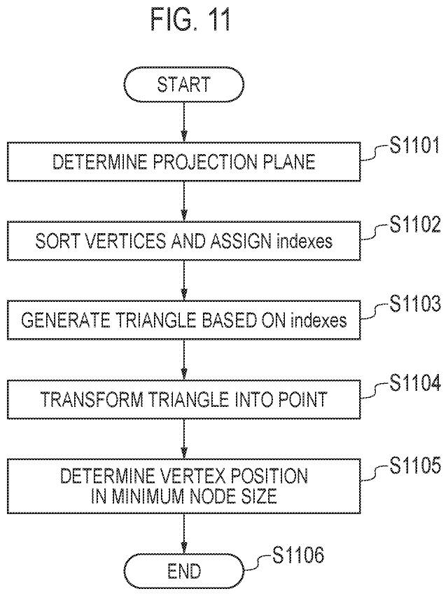

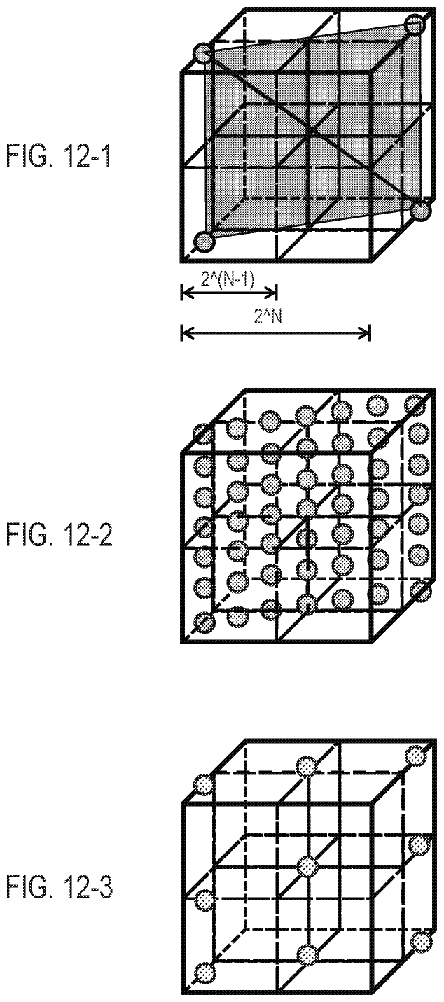

Hereinafter, an example of the processing of step S1006 described above will be described with reference to FIGS. 11 and 12.

FIGS. 12-1 to 12-3 illustrate an example of a case where the node size corresponding to the target Trisoup hierarchy decoded in step S1004 is N (the length of one side of the node is 2 to the power of N), and the minimum Trisoup node size is N−1.

The purpose of the processing of step S1006 is to generate vertices (nine points in FIGS. 12-1 to 12-3) in the minimum Trisoup node size (N−1 in FIGS. 12-1 to 12-3) illustrated in FIG. 12-3 from vertices (four points in FIGS. 12-1 to 12-3) in the node size (N in FIGS. 12-1 to 12-3) corresponding to the target Trisoup hierarchy illustrated in FIG. 12-1.

FIG. 11 is a flowchart illustrating an example of the processing of step S1006 described above.

As illustrated in FIG. 11, the approximate-surface synthesizing unit 2030 performs the processing of steps S1101 to S1104 using the vertex position in the node size corresponding to the target Trisoup hierarchy decoded in step S1004 as an input.

The processing of steps S1101 to S1104 can be implemented by a method similar to steps S902 to S905 in FIG. 9.

Here, FIG. 12-1 illustrates an example of a processing result (that is, an example of input data in step S1104) of step S1103, and FIG. 12-2 illustrates an example of a processing result of step S1104.

As illustrated in FIG. 12-1, in step S1104, the approximate-surface synthesizing unit 2030 generates points at all the intersections of the surface of the triangle and integer coordinate positions illustrated in FIG. 12-1.

The approximate-surface synthesizing unit 2030 converts the triangle illustrated in FIG. 12-1 into a point as illustrated in FIG. 12-2, and then proceeds to step S1105.

In step S1105, the approximate-surface synthesizing unit 2030 determines the vertex position in the minimum Trisoup node size from the points generated in step S1104.

Specifically, for example, the approximate-surface synthesizing unit 2030 can determine the vertex position for each side by extracting points adjacent to the side of each node corresponding to the minimum Trisoup node size from among the points generated in step S1104 and obtaining the average value of the coordinates of the extracted points.

For example, in a case where the position of the side is along the x axis direction, for example, in a case where the side is at a position satisfying (x,y,z)=(a to a+2(N−1), b, c), the approximate-surface synthesizing unit 2030 can determine (e,b,c) as the vertex position by, for example, extracting points existing in a region of (a to a+2 (N−1), b−1 to b, c−1 to c) and calculating an average value e of x-axis coordinates of those points.

The approximate-surface synthesizing unit 2030 can perform calculation in the same manner as described above even when the sides are along the y axis direction and the z axis direction.

Note that, in a case where no point exists in the region adjacent to the side, the approximate-surface synthesizing unit 2030 does not generate a vertex on the side.

As described above, the approximate-surface synthesizing unit 2030 can generate the vertex position in the minimum Trisoup node size, for example, as illustrated in FIG. 12-3.

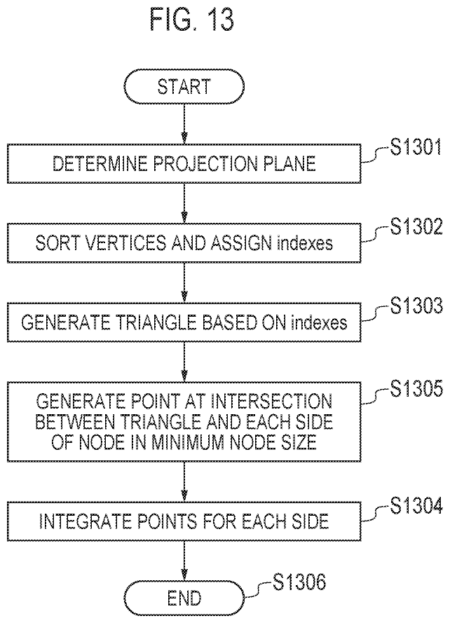

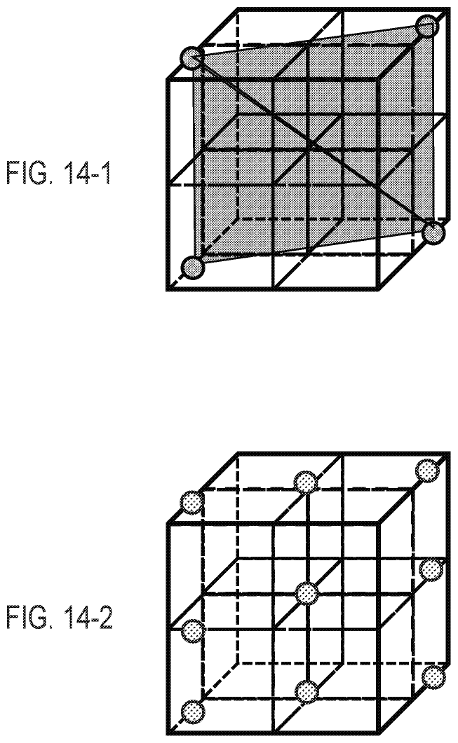

Next, another specific example of the processing of step S1106 will be described with reference to FIGS. 13 and 14.

FIG. 13 is a flowchart illustrating an example of the processing of step S1006.

As illustrated in FIG. 13, the approximate-surface synthesizing unit 2030 performs the processing of steps S1301 to S1303 using the vertex position in the node size corresponding to the target Trisoup hierarchy decoded in step S1004 as an input.

The processing of steps S1301 to S1303 can be implemented by a method similar to steps S902 to S904 in FIG. 9.

FIG. 14-1 illustrates an example of a processing result of step S1303. As can be seen from FIG. 14-1, the processing result of step S1303 and the processing result of step S1103 are similar.

As illustrated in FIG. 14-1, the approximate-surface synthesizing unit 2030 generates a triangle, and then proceeds to step S1304.

In step S1304, the approximate-surface synthesizing unit 2030 generates a point at an intersection of the surface of each triangle generated in step S1303 and each side of the node corresponding to the minimum Trisoup node size.

FIG. 14-2 illustrates an example of a processing result of step S1304. After generating a point on each side, the approximate-surface synthesizing unit 2030 proceeds to step S1305.

In step S1305, the approximate-surface synthesizing unit 2030 integrates the points generated on the sides corresponding to the minimum Trisoup node size in step S1304.

In the processing of step S1304, since the point is generated at the intersection between the surface of each triangle and the side, for example, in a case where the surfaces of two or more triangles intersect one side, there is a possibility that two or more vertices are generated on the same side.

In this case, the approximate-surface synthesizing unit 2030 may integrate the points existing on the same side and perform processing so that one vertex exists for each side.

Specifically, for example, a plurality of points can be integrated into one point by taking an average value of coordinates of vertices existing on a side.

As another example, in a case where the number of vertices is an odd number, the approximate-surface synthesizing unit 2030 can narrow down the vertices to one by selecting a point having a median value of the coordinates.

Furthermore, in a case where the number of vertices is an even number, the approximate-surface synthesizing unit 2030 extracts two points having the median value of the coordinates, and then averages the coordinate values of the two points, so that the vertices can be narrowed down to one.

After integrating the points on each side as described above, the approximate-surface synthesizing unit 2030 proceeds to step S1306 and ends the processing.

As described above, the approximate-surface synthesizing unit 2030 according to the present invention may be configured to decode, when Trisoup at a plurality of levels is enabled, the vertex position for each Trisoup node size as in step S1004 of FIG. 10, generate the vertex position in the minimum Trisoup node size from the vertex position as in step S1005, and generate the point in the minimum Trisoup node size as in step S905.

In other words, the approximate-surface synthesizing unit 2030 may be configured to perform vertex decoding processing for each of a plurality of node sizes, and perform point reconfiguration processing based on the vertex with a single node size.

Furthermore, as described above, the approximate-surface synthesizing unit 2030 may be configured to perform the vertex decoding processing for each node size between the maximum and minimum node sizes based on the maximum node size and the minimum node size decoded from the control data, generate, in a case where such a node size is not the minimum node size, the vertex position in the minimum node size based on the decoded vertex, set the single node size as the minimum node size, and perform the point reconfiguration processing based on the vertex position in the minimum node size.

With such a configuration, it is possible to improve a subjective quality of a decoded point cloud by performing the point reconfiguration with a single small node size while reducing a code amount of information related to the vertex according to a geometric characteristic of a point cloud by making the unit of decoding of the vertex position variable.

Furthermore, as described above, the approximate-surface synthesizing unit 2030 may be configured to generate, in a case where the node size is not the minimum node size, a point based on the decoded vertex, and generate a vertex position in the minimum node size based on coordinate values of the point existing in the vicinity of each side when the node of the node size is divided by the minimum node size among the generated points.

As described above, as a part of the point reconfiguration processing in the approximate-surface synthesizing unit 2030 is diverted to generate the vertex position in the minimum node size, a processing circuit and a processing function can be diverted, so that a design cost can be reduced.

Furthermore, as described above, the approximate-surface synthesizing unit 2030 may be configured to generate, in a case where the node size is not the minimum node size, a point only on each side when the node having the node size is divided by the minimum node size when generating a point based on the decoded vertex. In this way, by minimizing the number of points to be generated, a memory capacity and a processing amount required for the processing can be reduced.

Furthermore, as described above, the approximate-surface synthesizing unit 2030 may be configured to integrate, in a case where the node size is not the minimum node size, and a plurality of points exist on each side when the node of the node size is divided by the minimum node size, the points and generate the vertex position in the minimum node size in such a way that there is one vertex on each side when generating the points based on the decoded vertices. In this manner, by limiting the number of vertices to one on each side, the point reconfiguration processing can be simplified.

Furthermore, as described above, the approximate-surface synthesizing unit 2030 may be configured to integrate, in a case where a plurality of vertices generated from nodes of different node sizes adjacent to a certain side exist on the certain side, the points and generate the vertex position in such a way that one vertex exists on each side. With such a configuration, the point reconfiguration processing can be simplified.

Furthermore, as described above, the approximate-surface synthesizing unit 2030 may be configured to set, in a case where a plurality of vertices generated from nodes having different node sizes adjacent to a certain side exist on the certain side, a vertex generated by a node having the smallest node size among the adjacent nodes as a vertex position of the side. By using the vertex position in a small node size in this way, it is possible to reconfigure a point cloud in which more local features are reproduced, and the subjective quality is improved.

Next, a specific example of the processing of step S902 in FIG. 9 will be described.

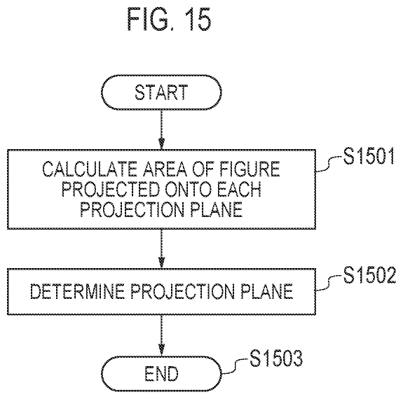

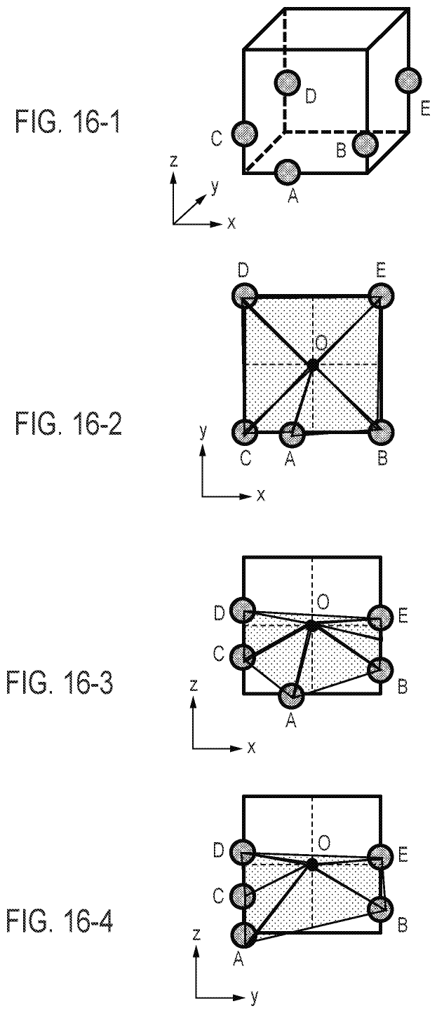

Hereinafter, an example of the processing of step S902 in FIG. 9 will be described with reference to FIGS. 15 and 16.

FIG. 15 is a flowchart illustrating an example of the processing of step S902.

As illustrated in FIG. 15, in step S1501, the approximate-surface synthesizing unit 2030 calculates the area of each polygon formed by vertices when the vertices are projected onto each projection plane.

FIGS. 16-1 to 16-4 illustrate a specific example of the processing of step S1501.

For example, a case where there are five vertices A to E for the target node as illustrated in FIG. 16-1 is assumed.

FIGS. 16-2 to 16-4 are diagrams when the vertices illustrated in FIG. 16-1 are projected onto the respective projection planes.

Here, the approximate-surface synthesizing unit 2030 calculates the area (the areas of shaded portions in FIGS. 16-2 to 16-4) of the polygon in each projection plane.

Specifically, assuming that the center of the square on each projection plane is an origin O, the approximate-surface synthesizing unit 2030 can calculate an area S of a triangle formed by a total of three points of the origin O and two vertices (for example, a point E and a point D in FIG. 16-2) adjacent to the origin O by the following expression.

S=|E×D|/2

Here, E and D mean vectors indicating three-dimensional coordinates of the point E and the point D with respect to the origin O, a symbol × means an operator for calculating an outer product of the vectors, and |·| means an L2 norm of the vectors.

The approximate-surface synthesizing unit 2030 can calculate the areas of the shaded portions in FIGS. 16-2 to 16-4 by sorting the vertices on each projection plane, for example, counterclockwise, by a method similar to step S903 by applying the above-described matters, obtaining the areas of all the triangles formed by adjacent vertices and the origin by a method similar to the above-described method, and then summing the areas.

Although a case where the center of the square on each projection plane is defined as the origin O has been described above, the area of the polygon can be calculated by a method similar to that described above even if the origin O is defined at another position as long as the origin O is on each projection plane.

For example, the approximate-surface synthesizing unit 2030 may position the origin O on a side of the square on the projection plane. Furthermore, for example, the approximate-surface synthesizing unit 2030 may define one of the vertices projected onto each projection plane as the origin O. For example, the approximate-surface synthesizing unit 2030 may sort the vertices projected onto each projection plane counterclockwise, and then use the first vertex as the origin O.

The approximate-surface synthesizing unit 2030 calculates the area of the polygon in each projection plane as described above, and then proceeds to step S1502.

In step S1502, the approximate-surface synthesizing unit 2030 determines a projection plane having the largest area of the polygon obtained in step S1501 as the projection plane.

After determining the projection plane, the approximate-surface synthesizing unit 2030 proceeds to step S1503 and ends the processing.

In a case of determining the projection plane by the method illustrated in FIG. 15, the approximate-surface synthesizing unit 2030 already sorts the vertices in step S1501, and thus the processing of step S903 can be omitted.

As described above, the approximate-surface synthesizing unit 2030 may be configured to select, as the above-described projection plane, a projection plane having the largest area of the polygon defined by a plurality of vertices existing on each side of the node when the plurality of vertices are projected onto each of a plurality of projection plane candidates.

With such a configuration, a projection plane having the largest two-dimensional spread can be selected. As a result, it is possible to prevent the subjective image quality of a decoded point cloud from deteriorating due to selection of an inappropriate projection plane.

As described above, the approximate-surface synthesizing unit 2030 may be configured to calculate the area of the polygon (triangle) described above by calculating the area of a triangle formed by three points of a predetermined origin, one (first vertex) of vertices projected onto the projection plane candidate described above, and a second vertex adjacent to the first vertex for all pairs of adjacent vertices.

As described above, by dividing the polygon into the small regions and obtaining the area, the area calculation processing of each of the small regions can be performed in parallel, so that the processing speed can be improved.

Furthermore, as described above, the approximate-surface synthesizing unit 2030 may be configured to define a first vector pointing from the above-described origin to the first vertex and a second vector pointing from the above-described origin to the second vertex, and calculate the area of the above-described triangle by using an outer product of the first vector and the second vector. In this way, in a case where the outer product processing is performed in other processing by performing computation using the outer product of the vectors, the design can be simplified by sharing the processing circuit or the processing function.

As described above, the approximate-surface synthesizing unit 2030 may sort the vertices projected onto the projection plane candidate counterclockwise or clockwise, and may set two consecutive vertices in the sorting order as the first vertex and the second vertex. In this manner, the sorting is performed by a method similar to step S903 in the subsequent stage, and it is thus possible to share the processing and prevent an increase in processing amount.

Furthermore, as described above, the approximate-surface synthesizing unit 2030 may be configured to set one (third vertex) of the vertices projected onto the projection plane candidate as the predetermined origin. With such a configuration, as compared with a case where the predetermined origin is set at a position other than the vertex, the number of triangles that need to be calculated to calculate the area of the polygon is reduced by one, so that an increase in amount of computation can be prevented.

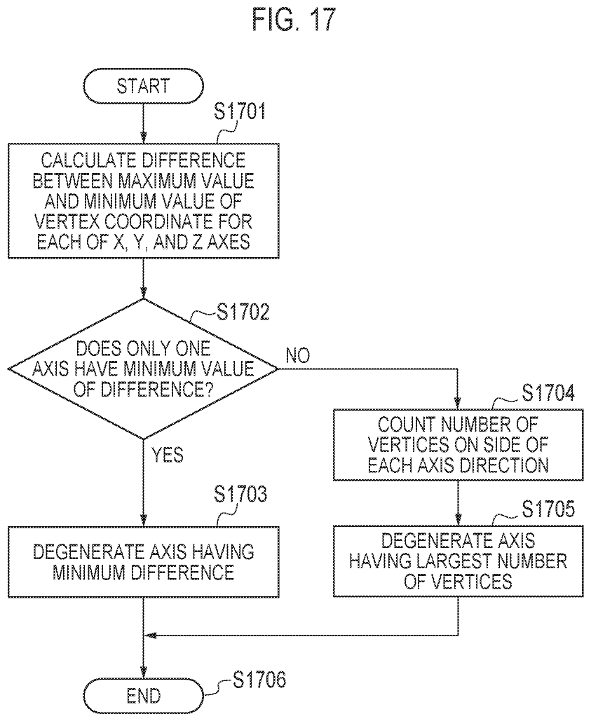

Next, another example of the processing of step S902 will be described with reference to FIGS. 17 to 20.

FIG. 17 is a flowchart illustrating an example of the processing of step S902.

As illustrated in FIG. 17, in step S1701, the approximate-surface synthesizing unit 2030 calculates a difference between the maximum value and the minimum value of the vertex coordinate in each of the x axis, y axis, and z axis directions.

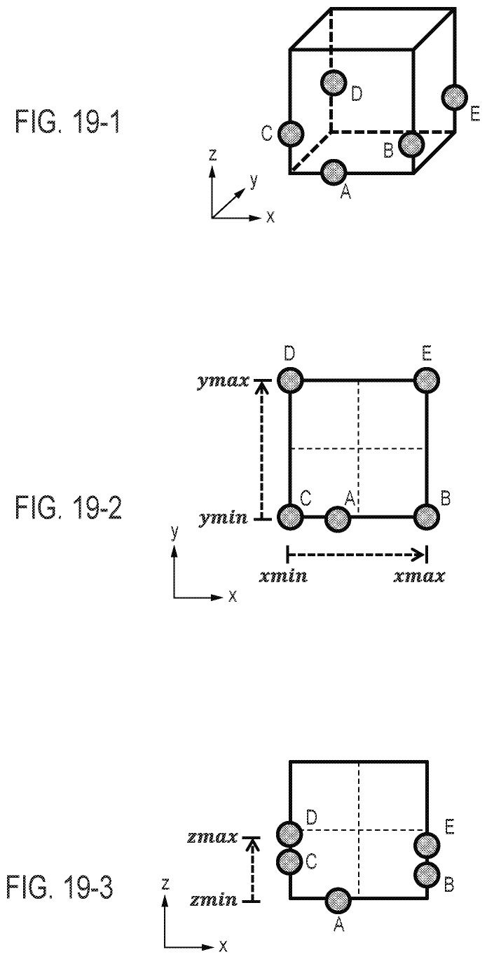

For example, when the target node has a total of five vertices A to E as illustrated in FIG. 19-1, the approximate-surface synthesizing unit 2030 calculates xmax−xmin (the difference between the maximum value and the minimum value of the coordinate value in the x axis direction), ymax−ymin (the difference between the maximum value and the minimum value of the coordinate value in the y axis direction) illustrated in FIG. 19-2, and zmax−zmin (the difference between the maximum value and the minimum value of the coordinate value in the z axis direction) illustrated in FIG. 19-3, and proceeds to step S1702.

In step S1702, the approximate-surface synthesizing unit 2030 checks the number of axis directions having the minimum value of the “difference between the maximum value and the minimum value” calculated in step S1701.

For example, in a case where zmax−zmin<xmax−xmin<ymax−ymin (alternatively, zmax−zmin<xmax−xmin=ymax−ymin), there is only one axis direction having the minimum value of the “difference between the maximum value and the minimum value”. In this case, the approximate-surface synthesizing unit 2030 proceeds to step S1703.

On the other hand, for example, in a case where zmax−zmin=xmax−xmin<ymax−ymin, the number of axis directions having the minimum value of the “difference between the maximum value and the minimum value” is two. In this case, the approximate-surface synthesizing unit 2030 proceeds to step S1704.

Step S1703 is processing corresponding to a case where there is only one axis direction having the minimum value of the difference, and in this case, the approximate-surface synthesizing unit 2030 determines the projection plane by degenerating the axis having the minimum difference.

For example, in a case where zmax−zmin<xmax−xmin<ymax−ymin as in the above example, the z axis is degenerated to determine the x-y plane as the projection plane.

After determining the projection plane, the approximate-surface synthesizing unit 2030 proceeds to step S1706 and ends the processing.

In step S1704, the approximate-surface synthesizing unit 2030 counts the number of vertices on a side in each axis direction.

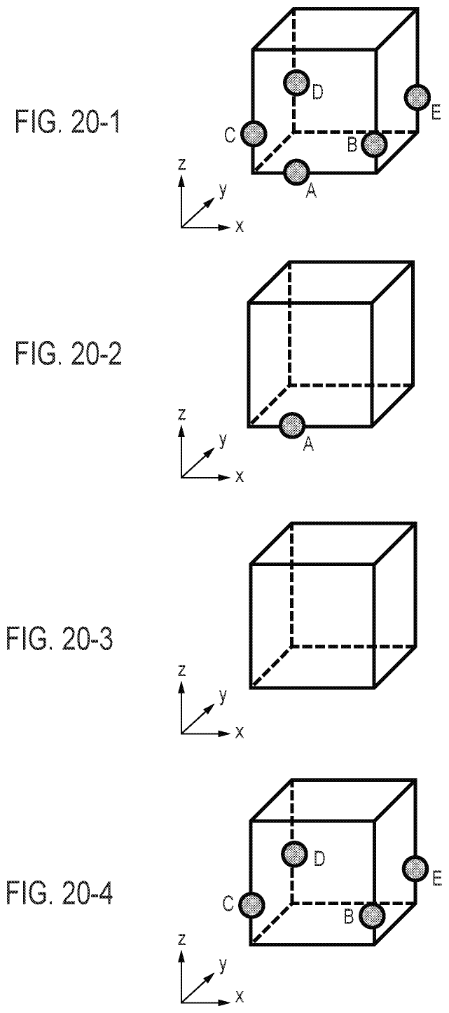

For example, as illustrated in FIG. 20-1, when the target node has a total of five vertices A to E, a vertex existing on the side in the x axis direction is only the point A illustrated in FIG. 20-2, no vertex exists on the sides in the y axis direction as illustrated in FIG. 20-3, and vertices existing on the sides in the z axis direction are a total of four points B to E as illustrated in FIG. 20-4.

The processing may be performed on all of the x, y, and z axes, or may be performed only on the axis direction having the minimum value of the “difference between the maximum value and the minimum value” obtained in step S1701.

For example, in a case where zmax−zmin=xmax−xmin<ymax−ymin, the processing targets of this step may be only the z axis and the x axis.

The approximate-surface synthesizing unit 2030 counts the number of vertices as described above, and then proceeds to step S1705.

In step S1705, the approximate-surface synthesizing unit 2030 determines the projection plane by degenerating an axis having the largest number of vertices in each axis direction calculated in step S1704.

For example, in the example of FIGS. 20-1 to 20-4, since the number of vertices existing on the side in the z axis direction is the largest, the approximate-surface synthesizing unit 2030 degenerates the z axis and determines the x-y plane as the projection plane.

After determining the projection plane, the approximate-surface synthesizing unit 2030 proceeds to step S1706 and ends the processing.

As described above, the approximate-surface synthesizing unit 2030 may be configured to classify each side of a node based on whether or not each side is parallel to any of coordinate axes of three-dimensional coordinates, count the number of vertices on the side classified as each coordinate axis, and determine the above-described projection plane from among the plurality of projection plane candidates by using the counted value (the number of vertices).

Furthermore, as described above, the approximate-surface synthesizing unit 2030 may be configured to determine a plane defined by degenerating an axis having the largest number of vertices as the above-described projection plane.

With such a configuration, it is possible to determine the projection plane in consideration of a two-dimensional spread of the vertex positions with a smaller amount of computation than the method described with reference to FIGS. 15 and 16.

As described above, the approximate-surface synthesizing unit 2030 may be configured to calculate a difference value between the maximum value and the minimum value of the coordinate value of each vertex for each coordinate axis of the above-described three-dimensional coordinates, and set, in a case where there are two or more axes having the minimum value of the difference value among the coordinate axes, a plane defined by degenerating an axis having the largest number of vertices on the side classified as each coordinate axis as the above-described projection plane.

Furthermore, as described above, the approximate-surface synthesizing unit 2030 may be configured to calculate, in a case where there are two or more axes having the largest number of vertices on the side classified as each coordinate axis, a difference value between the maximum value and the minimum value of the coordinate value of each vertex for each coordinate axis of the three-dimensional coordinates, and set a plane defined by degenerating an axis having the minimum difference value among the coordinate axes as the above-described projection plane.

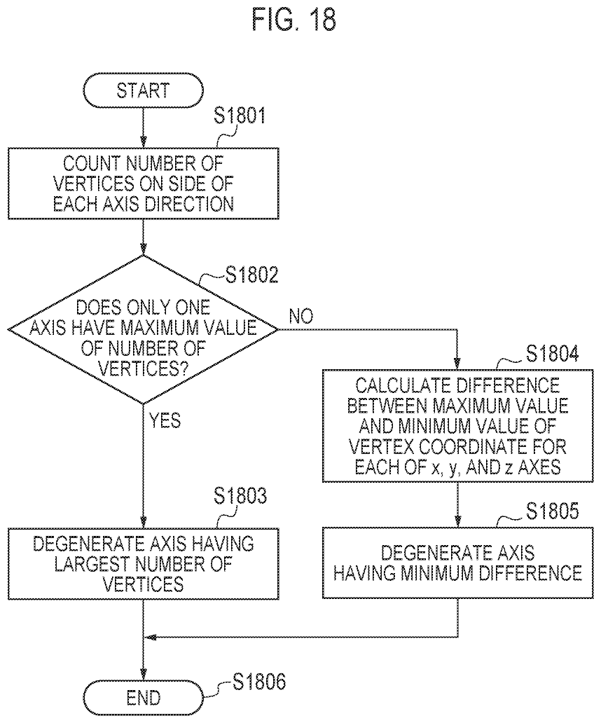

In FIG. 17, the approximate-surface synthesizing unit 2030 first evaluates the “difference between the maximum value and the minimum value” in steps S1701 and S1702, and then evaluates the number of vertices on the side in each axis direction in steps S1704 and S1705 as necessary. This order can be reversed, for example, as illustrated in FIG. 18.

For example, as illustrated in the example of FIG. 18, the approximate-surface synthesizing unit 2030 may evaluate the number of vertices on the side in each axis direction in steps S1801 and S1802, and then evaluate the “difference between the maximum value and the minimum value” in steps S1804 and S1805 as necessary.

In the example of FIG. 18, step S1801 can be implemented by processing similar to step S1704.

In step S1802, in a case where there is only one axis having the maximum number of vertices among the x axis, y axis, and z axis, the approximate-surface synthesizing unit 2030 proceeds to step S1803 and determines the projection plane by degenerating the axis having the maximum number of vertices.

Otherwise (when there are two or more axes having the maximum value of the number of vertices), the approximate-surface synthesizing unit 2030 proceeds to step S1804.

Step S1804 can be implemented by processing similar to step S1701.

Here, the processing target of step S1804 may be all of the x axis, the y axis, and the z axis, or only an axis direction having the maximum number of vertices in step S1802 may be the processing target.

In step S1805, the approximate-surface synthesizing unit 2030 determines the projection plane by degenerating an axis having the smallest difference value among the axes to be processed in step S1804.

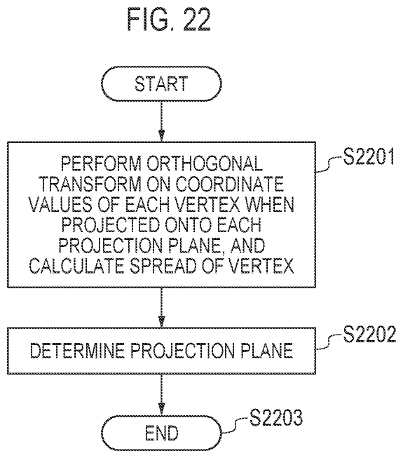

Next, another example of the processing of step S902 will be described with reference to FIG. 22. FIG. 22 is a flowchart illustrating an example of the processing of step S902.

As illustrated in FIG. 22, in step S2201, the approximate-surface synthesizing unit 2030 performs 2×2 orthogonal transform on the coordinates of each vertex when projected onto each projection plane.

Hereinafter, a case where the Hadamard transform is used as the orthogonal transform will be described as an example. For example, coordinates when a vertex P having (Px, Py, Pz) as coordinate values is projected onto the x-y plane are (Px, Py). On the other hand, coordinates (Ha, Hb) after the orthogonal transform obtained by performing 2×2 Hadamard transform can be calculated by the following expression.

$$( \begin{matrix}{H}_{a} \\ {H}_{b}\end{matrix} ) = \frac{1}{\sqrt{2}} ( \begin{matrix}1 & 1 \\ 1 & - 1\end{matrix} ) ( \begin{matrix}{P}_{x} \\ {P}_{y}\end{matrix} ) ←︀ \qquad [ Expression 1 ]$$

Here, 1/∇2 is a coefficient for normalizing the norm, but as will be described later, in this processing, the normalization coefficient 1/∇2 may be omitted because the coordinate values of each vertex after the orthogonal transform are used to compare a magnitude relationship. That is, the approximate-surface synthesizing unit 2030 may calculate (Ha, Hb) by the following expression.

$$( \begin{matrix}{H}_{a} \\ {H}_{b}\end{matrix} ) = ( \begin{matrix}1 & 1 \\ 1 & - 1\end{matrix} ) ( \begin{matrix}{P}_{x} \\ {P}_{y}\end{matrix} ) ←︀ \qquad [ Expression 2 ]$$

As described above, when the Hadamard transform is used as the orthogonal transform and the normalization coefficient is omitted, the approximate-surface synthesizing unit 2030 can calculate the coordinates (Ha, Hb) after the orthogonal transform only by addition and subtraction of the coordinate values Px and Py.

As described above, first, the approximate-surface synthesizing unit 2030 applies the orthogonal transform to each of vertices (1 to n) coordinate when projected onto the x-y plane to obtain n sets of coordinates (Hal, Hb1), . . . , and (Han, Hbn), and then detects maximum values Hamax and Hbmax and minimum values Hamin and Hbmin of the coordinate values on coordinate axes (here, an a axis and a b axis) after the orthogonal transform.

Next, difference values between the maximum values and the minimum values on the respective axes (Had=Hamax−Hamin and Hbd=Hbmax−Hbmin) are calculated.

Finally, the approximate-surface synthesizing unit 2030 calculates a variable Axy representing the magnitude of a spread of vertex coordinates in a case where the projection is performed on the x-y plane, by using Had and Hbd described above.

The approximate-surface synthesizing unit 2030 may calculate Axy by adding the differences between the maximum values and the minimum values of the coordinate values after the orthogonal transform on the respective axes, for example, Axy=Had+Hbd.

Furthermore, the approximate-surface synthesizing unit 2030 may calculate Axy by multiplying the differences between the maximum values and the minimum values of the coordinate values after the orthogonal transform on the respective axes, for example, as Axy=Had ×Hbd.

As described above, the approximate-surface synthesizing unit 2030 calculates Ayz corresponding to the y-z plane and Axz corresponding to the x-z plane, which are other projection plane candidates, and then proceeds to step S2202.

In step S2202, the approximate-surface synthesizing unit 2030 determines the projection plane based on Axy, Ayz, and Axz calculated in step S2201.

For example, the approximate-surface synthesizing unit 2030 can determine a projection plane corresponding to one having the largest value among Axy, Ayz, and Axz. Specifically, for example, in a case where Ayz>Axz>Axz, the approximate-surface synthesizing unit 2030 can determine the y-z plane as the projection plane.

As described above, after determining the projection plane, the approximate-surface synthesizing unit 2030 proceeds to step S2203 and ends the processing.

As described above, the approximate-surface synthesizing unit 2030 may be configured to determine the projection plane by using the coordinate values after the orthogonal transform obtained by applying the orthogonal transform to the vertex coordinate values at the time of projection onto each projection plane.

Furthermore, as described above, the approximate-surface synthesizing unit 2030 may be configured to calculate the difference value between the maximum value and the minimum value of the coordinate value on each coordinate axis after the orthogonal transform, and determine the projection plane based on the difference value.

Furthermore, as described above, the approximate-surface synthesizing unit 2030 may be configured to calculate the above-described difference value for all the coordinate axes after orthogonal transform for each projection plane candidate, and determine the projection plane by a sum of the difference values or a product of the difference values.

By using the coordinate values after rotation of the coordinate axes by the orthogonal transform in this manner, it becomes easy to evaluate a two-dimensional spread of the vertices.

Furthermore, as described above, the approximate-surface synthesizing unit 2030 may be configured to use the Hadamard transform as the orthogonal transform.

Furthermore, as described above, the approximate-surface synthesizing unit 2030 may be configured to omit the normalization coefficient at the time of the orthogonal transform.

With such a configuration, it is possible to obtain the coordinate value after the orthogonal transform only by adding or subtracting the coordinate value before orthogonal transform, and it is possible to prevent an increase in calculation amount.

### (Point Cloud Encoding Device 100)

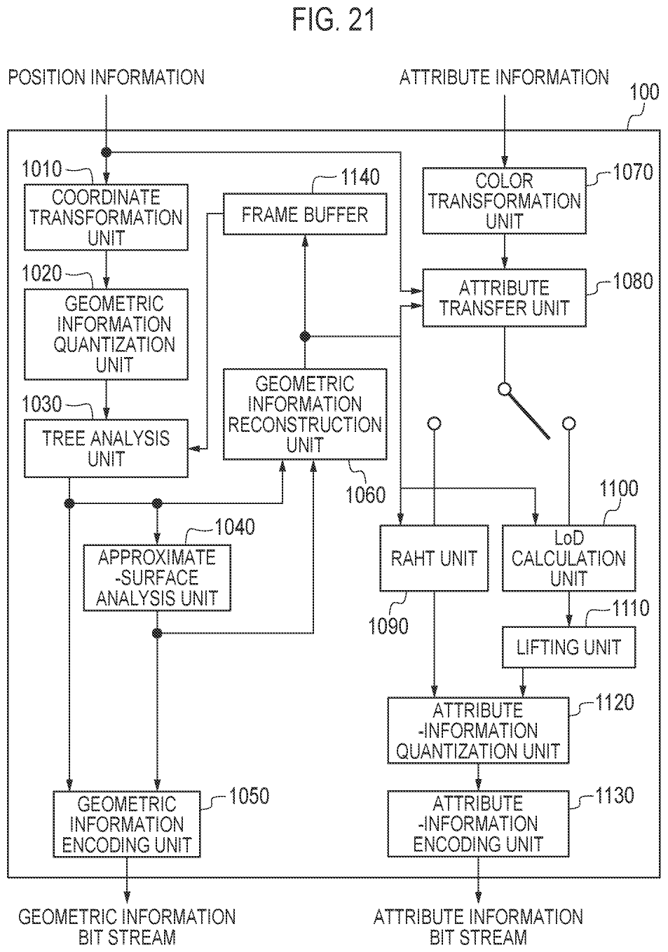

Hereinafter, the point cloud encoding device 100 according to the present embodiment will be described with reference to FIG. 21. FIG. 21 is a diagram illustrating an example of functional blocks of the point cloud encoding device 100 according to the present embodiment.

As illustrated in FIG. 21, the point cloud encoding device 100 includes a coordinate transformation unit 1010, a geometry information quantization unit 1020, a tree analysis unit 1030, an approximate-surface analysis unit 1040, a geometry information encoding unit 1050, a geometric information reconstruction unit 1060, a color transformation unit 1070, an attribute transfer unit 1080, an RAHT unit 1090, an LoD calculation unit 1100, a lifting unit 1110, an attribute-information quantization unit 1120, an attribute-information encoding unit 1130, and a frame buffer 1140.

The coordinate transformation unit 1010 is configured to perform transformation processing from a three-dimensional coordinate system of an input point cloud to an arbitrary different coordinate system. In the coordinate transformation, for example, x, y, and z coordinates of the input point cloud may be transformed into arbitrary s, t, and u coordinates by rotating the input point cloud. Furthermore, as one of variations of the transformation, the coordinate system of the input point cloud may be used as it is.

The geometry information quantization unit 1020 is configured to perform quantization of position information of the input point cloud after the coordinate transformation and removal of points having overlapping coordinates. Note that, in a case where a quantization step size is 1, the position information of the input point cloud matches position information after quantization. That is, a case where the quantization step size is 1 is equivalent to a case where quantization is not performed.

The tree analysis unit 1030 is configured to generate an occupancy code indicating which node in an encoding target space a point exists, based on a tree structure to be described later, by using the position information of the point cloud after quantization as an input.

In this processing, the tree analysis unit 1030 is configured to recursively partition the encoding target space into cuboids to generate the tree structure.

Here, in a case where a point exists in a certain cuboid, the tree structure can be generated by recursively performing processing of dividing the cuboid into a plurality of cuboids until the cuboid has a predetermined size. Each of such cuboids is referred to as a node. In addition, each cuboid generated by dividing the node is referred to as a child node, and the occupancy code is a code expressed by 0 or 1 as to whether or not a point is included in the child node.

As described above, the tree analysis unit 1030 is configured to generate the occupancy code while recursively dividing the node to a predetermined size.

In the present embodiment, it is possible to use a method called “Octree” in which octree division is recursively carried out with the above-described cuboids always as cubes, and a method called “QtBt” in which quadtree division and binary tree division are carried out in addition to octree division.

Here, whether or not to use “QtBt” is transmitted to the point cloud decoding device 200 as control data.

Alternatively, it may be specified that Predictive coding using any tree configuration is to be used. In such a case, the tree analysis unit 1030 determines the tree structure, and the determined tree structure is transmitted to the point cloud decoding device 200 as control data.

For example, the control data of the tree structure may be configured to be decoded by the procedure described in FIG. 6.

The approximate-surface analysis unit 1040 is configured to generate approximate-surface information by using the tree information generated by the tree analysis unit 1030.

For example, in a case where a point cloud is densely distributed on the surface of an object when decoding three-dimensional point cloud data of the object or the like, the approximate-surface information approximates and expresses a region in which the point cloud exists by a small plane instead of decoding each point cloud.

Specifically, the approximate-surface analysis unit 1040 may be configured to generate the approximate-surface information by, for example, a method called “Trisoup”. In addition, when decoding a sparse point cloud acquired by Lidar or the like, this processing can be omitted.

The geometry information encoding unit 1050 is configured to encode a syntax such as the occupancy code generated by the tree analysis unit 1030 and the approximate-surface information generated by the approximate-surface analysis unit 1040 to generate a bit stream (geometry information bit stream). Here, the bit stream may include, for example, the syntax described in FIGS. 4 and 5.

The encoding processing is, for example, context-adaptive binary arithmetic encoding processing. Here, for example, the syntax includes control data (flag or parameter) for controlling decoding processing of position information.

The geometric information reconstruction unit 1060 is configured to reconfigure geometry information (a coordinate system assumed by the encoding processing, that is, the position information after the coordinate transformation in the coordinate transformation unit 1010) of each point of the point cloud data to be encoded based on the tree information generated by the tree analysis unit 1030 and the approximate-surface information generated by the approximate-surface analysis unit 1040.

The frame buffer 1140 is configured to receive the geometry information reconfigured by the geometric information reconstruction unit 1060 as an input and store the geometry information as a reference frame.

The stored reference frame is read from the frame buffer 1140 and used as a reference frame in a case where the tree analysis unit 1030 performs inter prediction of temporally different frames.

Here, which time reference frame is used for each frame may be determined based on, for example, a value of a cost function representing encoding efficiency, and information of the reference frame to be used may be transmitted to the point cloud decoding device 200 as the control data.

The color transformation unit 1070 is configured to perform color transformation when attribute information of the input is color information. The color transformation is not necessarily performed, and whether or not to perform the color transformation processing is encoded as a part of the control data and transmitted to the point cloud decoding device 200.

The attribute transfer unit 1080 is configured to correct an attribute value in such a way as to minimize distortion of the attribute information based on the position information of the input point cloud, the position information of the point cloud after the reconfiguration in the geometric information reconstruction unit 1060, and the attribute information after the color change in the color transformation unit 1070. As a specific correction method, for example, the method described in Literature 2 (Text of ISO/IEC 23090-9 DIS Geometry-based PCC, ISO/IEC JTC1/SC29/WG11 N19088) can be applied.

The RAHT unit 1090 is configured to receive the attribute information after the transfer by the attribute transfer unit 1080 and the geometry information generated by the geometric information reconstruction unit 1060 as inputs, and generate residual information of each point by using a type of Haar transform called region adaptive hierarchical transform (RAHT). As specific processing of the RAHT, for example, the method described in Literature 2 described above can be used.

The LOD calculation unit 1100 is configured to generate a level of detail (LoD) using the geometry information generated by the geometric information reconstruction unit 1060 as an input.

The LOD is information for defining a reference relationship (a point that refers to and a point to be referred to) for implementing predictive coding such as encoding or decoding of a prediction residual by predicting attribute information of a certain point from attribute information of another certain point.

In other words, the LOD is information defining a hierarchical structure in which each point included in the geometry information is classified into a plurality of levels, and for a point belonging to a lower level, an attribute is encoded or decoded using attribute information of a point belonging to an upper level.

As a specific LOD determination method, for example, the method described in Literature 2 described above may be used.

The lifting unit 1110 is configured to generate the residual information by lifting processing using the LOD generated by the LOD calculation unit 1100 and the attribute information after the attribute transfer in the attribute transfer unit 1080.

As a specific processing of the lifting, for example, the method described in Literature 2 described above may be used.

The attribute-information quantization unit 1120 is configured to quantize the residual information output from the RAHT unit 1090 or the lifting unit 1110. Here, a case where the quantization step size is 1 is equivalent to a case where quantization is not performed.

The attribute-information encoding unit 1130 is configured to perform encoding processing using the quantized residual information or the like output from the attribute-information quantization unit 1120 as a syntax to generate a bit stream (attribute information bit stream) regarding the attribute information.

The encoding processing is, for example, context-adaptive binary arithmetic encoding processing. Here, for example, the syntax includes control data (flag and parameter) for controlling decoding processing of the attribute information.

The point cloud encoding device 100 is configured to perform the encoding processing using the position information and the attribute information of each point in a point cloud as inputs and output the geometry information bit stream and the attribute information bit stream by the above processing.

Further, the point cloud encoding device 100 and the point cloud decoding device 200 may be realized as a program causing a computer to execute each function (each step).

Note that the above described embodiments have been described by taking application of the present invention to the point cloud encoding device 10 and the point cloud decoding device 30 as examples. However, the present invention is not limited only thereto, but can be similarly applied to an encoding/decoding system having functions of the encoding device 10 and the decoding device 30.

According to the present embodiment, it is possible to improve the overall quality of service in video communications, thereby contributing to Goal 9 of the UN-led Sustainable Development Goals (SDGs) which is to “build resilient infrastructure, promote inclusive and sustainable industrialization and foster innovation”.

What is claimed is:

1. A point cloud decoding device comprising a circuit that selects, as a projection plane, a projection plane having a largest area of a polygon defined by a plurality of vertices existing on sides of a node when the plurality of vertices are projected onto each of a plurality of projection plane candidates, from among the plurality of projection plane candidates.

2. The point cloud decoding device according to claim 1, wherein
the circuit calculates the area of the polygon by calculating an area of a triangle including three points of a predetermined origin, a first vertex which is one of the vertices projected onto the projection plane candidate, and a second vertex adjacent to the first vertex for all pairs of adjacent vertices.

3. The point cloud decoding device according to claim 2, wherein
the circuit:
defines a first vector pointing from the origin to the first vertex and a second vector pointing from the origin to the second vertex, and
calculates the area of the triangle by using an outer product of the first vector and the second vector.

4. The point cloud decoding device according to claim 2, wherein
the circuit sorts the vertices projected onto the projection plane candidate counterclockwise or clockwise, and set two consecutive vertices in the sorting order as the first vertex and the second vertex.

5. The point cloud decoding device according to claim 2, wherein
the circuit sets a third vertex, which is one of the vertices projected onto the projection plane candidate, as the predetermined origin.

6. A point cloud decoding device comprising a circuit that classifies each side of a node based on whether or not each side is parallel to any of coordinate axes of three-dimensional coordinates, and determine the projection plane from among a plurality of projection plane candidates by using the number of vertices on the side classified as each coordinate axis.

7. The point cloud decoding device according to claim 6, wherein
the circuit determines a plane defined by degenerating an axis having a largest number of vertices as the projection plane.

8. The point cloud decoding device according to claim 6, wherein
the circuit:
calculates a difference value between a maximum value and a minimum value of a coordinate value of each vertex for each coordinate axis of the three-dimensional coordinates, and
sets, in a case where there are two or more axes having a minimum value of the difference value among the coordinate axes, a plane defined by degenerating an axis having a largest number of vertices on the side classified as each coordinate axis as the projection plane.

9. The point cloud decoding device according to claim 6, wherein
the circuit:
calculates, in a case where there are two or more axes having a largest number of vertices on the side classified as each coordinate axis, a difference value between a maximum value and a minimum value of a coordinate value of each vertex for each coordinate axis of the three-dimensional coordinates, and
sets a plane defined by degenerating an axis having a minimum value of the difference value among the coordinate axes as the projection plane.

10. A point cloud decoding method comprising:
selecting, as a projection plane, a projection plane having a largest area of a polygon defined by a plurality of vertices existing on sides of a node when the plurality of vertices are projected onto each of a plurality of projection plane candidates, from among the plurality of projection plane candidates.

11. A program stored on a non-transitory computer-readable medium for causing a computer to function as a point cloud decoding device including a circuit that selects, as a projection plane, a projection plane having a largest area of a polygon defined by a plurality of vertices existing on sides of a node when the plurality of vertices are projected onto each of a plurality of projection plane candidates, from among the plurality of projection plane candidates.
